(19) United States
(12) Patent Application Publication
(10) Pub. No.: US 2025/0287211 A1
(43) Pub. Date: Sep. 11, 2025

(54) Covert Communication State for Unauthorized Device Shutdowns

(71) Applicant: QUALCOMM Incorporated, San Diego, CA (US)

(72) Inventors: Sagar BAMASHETTI, Chadchan (IN); Hithesh Hassan LEPAKSHA, Hyderabad (IN); Sharath Kumar NAGILLA, Hyderabad (IN)

(21) Appl. No.: 18/596,583

(22) Filed: Mar. 5, 2024

(51) Int. Cl. H04W 12/126; G06F 1/3206; H04W 12/06; H04W 12/30; H04W 52/02

(52) U.S. Cl. CPC H04W 12/126; G06F 1/3206; H04W 12/06; H04W 12/30; H04W 52/0274

(57) ABSTRACT

Methods of maintaining covert communications by a user equipment, including determining whether a user-initiated shutdown of a user equipment (UE) was initiated by an authorized user, providing a notification to a processor configured to remain ON in response to determining that the user-initiated shutdown was not initiated by an authorized user, transitioning the UE to a covert low power mode managed by a state manager in response to the notification, where the covert low power mode supplies power to one or more transceivers, and transmitting a location of the UE while in the covert low power mode.

### BACKGROUND

As the cost of electronic devices increases with their increasing capabilities, the risk of theft has also increased. When a smartphone electronic device is stolen, much more than the device is often lost, including sensitive data, personal data, and access to financial information. Users may install applications that assist in locating a stolen electronic device by broadcasting its location upon receiving a wireless message requesting such a response, or periodically broadcasting its location while the device is on. Unfortunately, thieves are aware of these application capabilities and may turn off a stolen device to disable such applications and defeat attempts to locate the stolen device by the owner.

### SUMMARY

Various aspects include methods and a user device that maintains location communication when a user equipment, such as a smartphone or similar computing device, is shut down in an unauthorized manner. Various aspects may include a processor within a user equipment (UE) determining whether a user-initiated shutdown of the UE was initiated by an authorized user, providing a notification to a processor configured to remain ON in response to determining that the user-initiated shutdown was not initiated by an authorized user, transitioning the UE to a covert low power mode managed by a state manager in response to the notification, in which the covert low power mode supplies power to one or more transceivers, and transmitting a location of the UE while in the covert low power mode.

In some aspects, transitioning to the covert low power mode may further include turning OFF at least two of: a digital signal processor (DSP), an image signal processor (ISP), a secure processor, a visual display processor, or an audio processor. In some aspects, determining whether a user-initiated shutdown of the UE was initiated by the authorized user may include determining that the user-initiated shutdown was not initiated by the authorized user in response to an authentication failure as a part of the user-initiated shutdown. In some aspects, transitioning the UE to the covert low power mode managed by the state manager may include the state manager configuring a first set of processors and transceivers that are powered in the covert low power mode and configuring a second set of processors and transceivers that are in reset in the covert low power mode.

Some aspects may further include periodically and iteratively power ON each of the one or more transceivers while the UE is in the covert low power mode, the one or more transceivers including at least one of a 5G transceiver, a Wi-Fi transceiver, a BLUETOOTH transceiver, or a near-field communication (NFC) transceiver. Some aspects may further include processing a received global positioning satellite (GPS) signal to determine the location of the UE while in the covert low power mode, and transmitting the location of the UE determined from the GPS signal while in the covert low power mode.

Some aspects may further include emulating user-facing functionality of a full shutdown of the UE while the UE is in the covert low power mode. Some aspects may further include receiving a power ON signal while in the covert low power mode, initiating a normal boot sequence from the covert low power mode upon receiving the power ON signal, and returning to the covert low power mode if the authorized user does not authenticate during the normal boot sequence.

Further aspects include a computing device, such as a UE, having a processing system including one or more processors configured to perform operations of any of the methods summarized above. Further aspects include a computing device, such as a UE, including means for performing functions of any of the methods summarized above. Further aspects include firmware for use in a computing device, the firmware executing on a processing system to perform the operations of any of the methods summarized above.

Further aspects may include a UE having a wireless transceiver, a covert processor, a covert state manager, and a processor executing an operating system coupled to the wireless transceiver, covert processor and covert state manager, in which the processor may be configured to notify the covert state manager in the event of a hard shutdown of the UE without authentication of a user, the covert state manager may be configured to initiate a covert low power mode by signaling the wireless transceiver and the covert processor to enter the covert low power mode and powering down the processor and other subcomponents of the UE, the wireless transceiver may be configured to periodically monitor for an accessible wireless network while in the covert low power mode and signal the covert processor in response to identifying an accessible wireless network, and the covert processor may be configured to cause the wireless transceiver to transmit information including UE location and status information in response to the signal identifying the accessible network.

In some aspects, the UE may further include a Global Positioning System (GPS) receiver coupled to the covert processor, in which the covert processor is further configured to request UE location information from the GPS receiver in response to the signal identifying the accessible network, and provide UE location information received from the GPS receiver to the wireless transceiver for inclusion in transmissions of UE location and status information.

In some aspects, the wireless transceiver may include at least one of a 5G transceiver, a Wi-Fi transceiver, a BLUETOOTH transceiver, or a near-field communication (NFC) transceiver. In some aspects, the covert processor may be further configured to emulate user-facing functionality of a full shutdown of the UE while the UE is in the covert low power mode.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating various shutdown states suitable for implementing any of the various embodiments.

FIG. 2 is a component block diagram illustrating an example computing device suitable for implementing any of the various embodiments.

FIG. 3 is a component block diagram illustrating an example system to enable covert communication after unauthorized shutdown according to various embodiments.

FIG. 4 is a timing diagram illustrating communication in authorized and unauthorized shutdowns according to various embodiments.

FIG. 5 is a process flow diagram of an example method for switching to a covert state in an unauthorized shutdown according to various embodiments.

FIG. 6 is a process flow diagram of an example method for switching to a covert state in an unauthorized restart/shutdown according to various embodiments.

FIG. 7 is a component block diagram illustrating an example computing device suitable for use with the various embodiments.

FIG. 8 is a component block diagram illustrating an example wireless communication device suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments described herein include methods and UE devices that perform a semi-active shutdown when a powering OFF of the UE is not accompanied by an authorization or authentication. The semi-active shutdown may include emulating the user-facing functionality of a full shutdown so that an unauthorized holder of the phone would think it is fully OFF. A user equipment (UE) may enter the covert mode/state or semi-active shutdown by determining whether a user-initiated shutdown of a user equipment (UE) was initiated by an authorized user, providing a notification to a processor configured to remain ON in response to determining that the user-initiated shutdown was not initiated by an authorized user, transitioning the UE to a covert low power mode managed by a state manager in response to the notification, wherein the covert low power mode supplies power to one or more transceivers, and transmitting a location of the UE while in the covert low power mode.

The term “user equipment” (UE) is used herein to refer to a variety of mobile computing and communication devices, including but not limited to smartphones, cellular telephones, tablet computers, laptop computers, smart watches, wearable computers, mobile multi-media players, personal data assistants (PDAs), wireless electronic mail receivers, multimedia Internet enabled cellular telephones and similar personal electronic devices that include a processing system, memory, and one or more wireless transceivers.

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

As used herein, the term “processing system” is used herein to refer to one more processors, including multi-core processors, that are organized and configured to perform various computing functions. Various embodiment methods may be implemented in one or more of multiple processors within a vehicle processing system as described herein.

The loss of a UE, such as a smartphone, presents a significant challenge for individuals and society. As UE devices have become an integral part of life, the consequences of losing one's UE extends beyond the financial loss. Losing a UE raises concerns about privacy, security, and the potential misuse of personal information. Recovering a lost or stolen UE is important for several reasons: cost, personal data, and convenience. Tracking a lost UE may now be possible via phone applications, but several challenges remain that can impact the effectiveness of such an application.

For example, several factors that contribute to the inefficiencies of relying on tracking applications on a running UE include: (1) shut down with long key press or airplane mode to render a UE incommunicable; (2) internet connectivity disconnection since tracking services rely on the UE having an active internet connection; (3) privacy settings where if the lost UE has privacy settings enabled, it may restrict or prevent tracking attempts; (4) SIM card removal or replacement to eliminate the owner's mobile network-based methods for tracking the UE.

In various embodiments, to prevent complete loss of connectivity during unauthorized shutdown/disconnect (e.g., by a thief), a UE may be configured to implement a secure disconnect shutdown in which the UE enters a complete shutdown/disconnect only when the user-initiated shutdown is authenticated by the user (e.g., by fingerprint, facial recognition, pin/passcode, etc.). If the user fails to authenticate the user-initiated shutdown, an unauthorized shutdown is presumed and the UE may enter a semi-active state which is referred to herein as a “covert low power mode” that is configured to conserve power by deactivating most functionality and components, support covert communications mode to communicate location information, and otherwise emulate a full/complete shutdown so that a thief will not recognize that the UE is semi-active and communicating location information.

While in the covert low power mode and emulating functionality as if the UE is completely shut down, the UE may maintain various communication channels active in the background to remotely communicate through a cellular connection, Wi-Fi, Bluetooth®, 5G sidelink to a nearby UE, or other wireless connections. The covert low power mode may be a semi-active state that is configured in terms of selectively turning selected sub-components ON and OFF, as well as other power saving techniques, to extend the operating time of the UE powered solely by the battery, while supporting covert communications as described herein. The covert low power mode may be defined in a hardware state or firmware of a covert communication state manager that may execute in an always-on-subsystem or always on processor.

For example, a processing system SoC may include a common power rail supplying power to components and one or more state machines that are part of the hardware, firmware, or embedded software of the SoC may manage the power applied to selected components in various operating states or modes. For example, state machines may include a default state machine for normal operation of the UE, a boot state machine, and a semi-active or covert low power mode state machine. A semi-active or covert low power mode state machine may optimize low-bandwidth communication potential and battery life for the UE as described herein.

Various embodiments may enable the UE to boot normally after being placed into a semi-active state due to an unauthorized shutdown. To preserve battery life, the UE may return to the covert low power mode if no authentication or activity has taken place on the UE for a given period of time. Some embodiments include a covert low power mode state machine configured to selectively or intermittently power ON different transceivers for different communication modes to establish communication back to a host to report location and status.

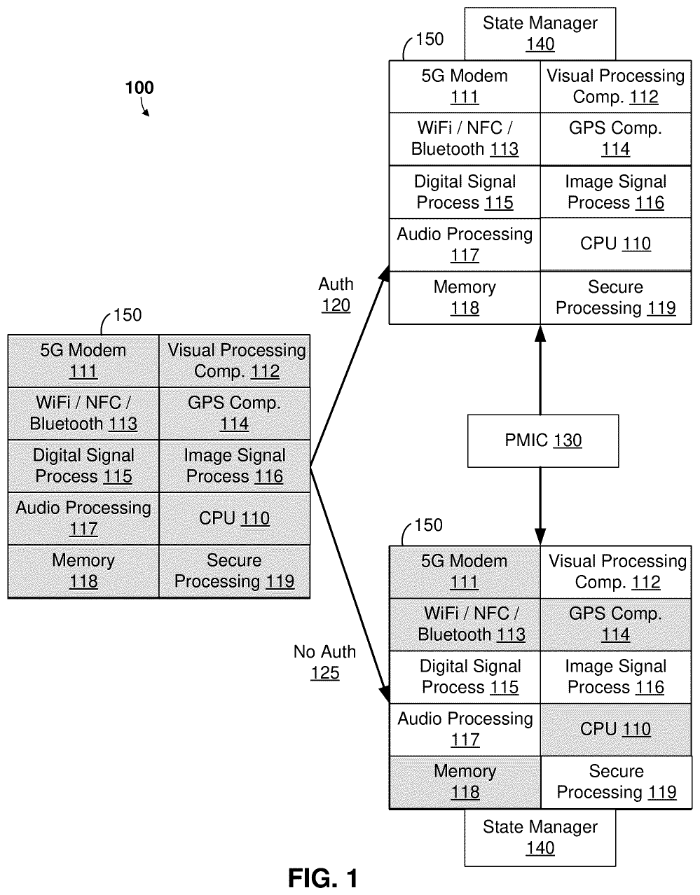

FIG. 1 is a system block diagram illustrating an example system suitable for implementing any of the various embodiments. The system 100 may include a processing system that includes one or more processors for performing covert communication after an unauthorized shutdown of a device. For example, the system 100 may include a processing system, which may be integrated on an SoC 150 including a 5G modem 111, a visual processing component 112, a Wi-Fi transceiver, NFC transceiver, and Bluetooth transceiver (together 113), a global positioning satellite (GPS) receiver component 114, a digital signal processor 115, an image signal process or processor 116, an audio processing component 117, a central processing unit (CPU), a memory 118 (e.g., system memory or random access memory), a GPU, and a secure processor 119. In a normal operation mode (e.g., when authorized user is actively using the device), a state machine or state manager (e.g., state manager 140) may power ON all these components of processing system/SoC 150 (as illustrated by shading).

A user (or mere inactivity/isolation) may then turn OFF the SoC 150 of the UE by using one of the hardware or application-based OFF switches (e.g., long press on physical button). As a part of this user-initiated shutdown, the user may be asked to authenticate the shutdown, or the shutdown may be initiated in a secure, authenticated application of the UE, or the shutdown may be unauthenticated (e.g., long press or battery removal). In an authenticated shutdown 120, the state manager 140 may enter or switch the SoC 150 to an OFF state or a reset state. As illustrated (by no shading), the subcomponents of the SoC 150 are then turned OFF and not supplied power by the power management integrated circuit (PMIC) 130 in the OFF state.

In an unauthenticated shutdown 125 (e.g., simple long press or battery removal and battery replacement), the state manager 140 may enter or switch to a semi-active state for covert communication with a covert lower power mode. In this semi-active state, the state manager 140 controls the PMIC 130 to shut off power to one or more subcomponents. For example, to enable low-power, covert communications, the CPU 110, the system memory 118, the Wi-Fi transceiver, NFC transceiver, and Bluetooth transceiver (together 113), global positioning satellite (GPS) receiver component 114, and a 5G (or other cellular) modem 111 may remain powered on or in a semi-active state while other hardware components are powered off. The state manager 140 or the processes (e.g., firmware) executing on the CPU 110 and memory 118 as part of the semi-active state may selectively or iteratively shutdown (power off) various subcomponents, such as 5G modem 111, Wi-Fi, NFC, Bluetooth, and GPS 114, to save further energy. In some embodiments, the covert communication of the semi-active state may default to the longest-range communication mode or the lowest energy mode and may be configured to cycle to (turn on) other communication modes when no connection can made with the default connection.

In summary, an SoC 150 or a mobile device thereof may operate in at least three different states including an ON state, a semi-active state, and a reset/OFF state. In FIG. 1, the SoC 150 to the left that is fully shaded depicts an SoC in an ON mode for normal operation (i.e., before a power OFF is initiated). The partially-shaded SoC 150 on the lower right of FIG. 1 depicts the SoC in a semi-active state following a power OFF event that was not properly authenticated (e.g., no auth 125). The unshaded SoC 150 in the top right of FIG. 1 depicts an SoC in reset following a power OFF event that was properly authenticated (e.g., auth 120).

In all three cases illustrated in FIG. 1 (i.e., the normal operation, the reset state, and the semi-active state), the SoC 150 may include one or more firmware processes, hardware processes, and software processes that execute as part of the state manager 140 to define the operations performed to transition from one state to another state. The hardware states described here for the SoC 150 are not limiting and further states may be defined, as the case may be, including dividing the semi-active state into multiple states to optimize various parameters (e.g., low power). The shutdown of the UE (authenticated or unauthenticated) may include an always-on processor which may be embodied as an application specific integrated circuit (ASIC) or firmware executing on a general-purpose controller. For example, the always-on processor may respond to an ON signal (e.g., long button press) and initiate boot processes when the SoC 150 is OFF. The always-on processor may be connected to or a part of the PMIC 130 or the SoC 150.

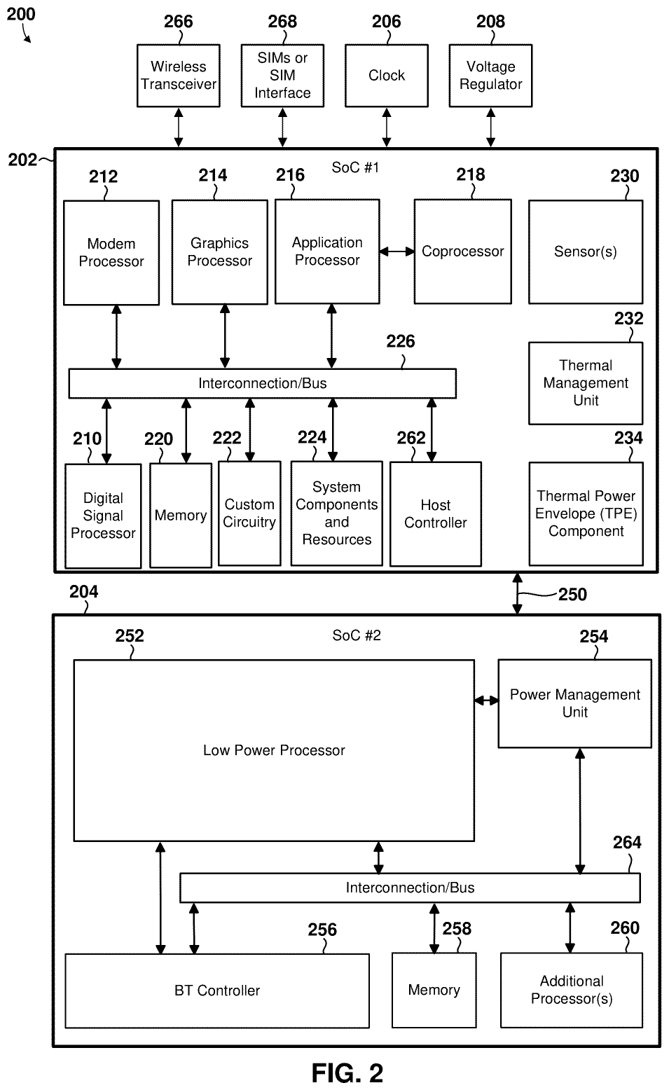

FIG. 2 is a component block diagram illustrating an example computing device 200 suitable for implementing any of the various embodiments. Various embodiments may be implemented on a number of single processor and multiprocessor computer systems, including a system-on-chip (SoC) or system in a package. In other words, a single SoC (e.g., SoC 150) may implement the structures of computing device 200.

With reference to FIGS. 1-2, the illustrated example computing device 200 (which may be a system-in-a-package in some embodiments) includes two SoCs 202, 204 that may be coupled to a clock 206, a voltage regulator 208 (e.g., PMIC 130), at least one subscriber identity module (SIM) 268 and/or a SIM interface and a wireless transceiver 266 configured to send and receive wireless communications via an antenna (not shown) to/from wireless computing devices. In some embodiments, the first SoC 202 may operate as central processing unit (CPU) of the computing device 200 that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 202 may include a digital signal processor (DSP) 210 (e.g., 115), a modem processor 212 (e.g., 111/113), a graphics processor 214, an application processor (AP) 216, one or more coprocessors 218 (e.g., vector co-processor) connected to one or more of the processors, memory 220 (e.g., 118), custom circuity 222 (e.g., always-on processor), system components and resources 224, a host controller 262, an interconnection/bus module 226, one or more sensors 230 (e.g., accelerometer, temperature sensor, pressure sensor, optical sensor, infrared sensor, analog sound sensor, etc.), a thermal management unit 232, and a thermal power envelope (TPE) component 234. The second SoC 204 may include a low power processor 252, a power management unit 254, an interconnection/bus module 264, a Bluetooth (BT) controller 256, memory 258, and various additional processors 260, such as an applications processor, packet processor, etc.

Each processor 210, 212, 214, 216, 218, 252, 260 may include one or more cores, and each processor/core may perform operations independent of the other processors/cores. Processors 210, 212, 214, 216, 218, 252, 260 may be referred to independently or collectively as a processing system. The first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second SoC 202, 204 may communicate via interconnection/bus module 250. In some embodiments, the interconnection/bus module may be a connection established by transceiving (i.e., receiving and transmitting) components within both the SoC 202 and SoC 204. For example, the low power processor 252 may include a universal asynchronous receiver-transmitter (UART) and the application processor 216 may include a multiple signal messages (MSM) UART driver that is communicatively connected to the UART of the low power processor 252.

The various processors 210, 212, 214, 216, 218, may be interconnected to one or more memory elements 220, system components and resources 224, and custom circuitry 222, and a thermal management unit 232 via an interconnection/bus module 226. Similarly, the low power processor 252 may be interconnected to the power management unit 254, the BT controller 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266, and at least one SIM 268 and/or SIM interface (i.e., an interface for receiving one or more SIM cards). Resources external to the SoC (e.g., clock 206, voltage regulator 208) may be shared by two or more of the internal SoC processors/cores. The at least one SIM 268 (or one or more SIM cards coupled to one or more SIM interfaces) may store information supporting multiple subscriptions, including a first 5GNR subscription and a second 5GNR subscription, etc.

In addition to the example computing device 200 discussed above, various embodiments may be implemented in a wide variety of computing systems, which may include a single processor, multiple processors, multicore processors, or any combination thereof-any of which may be referred to as a processing system. In some embodiments, the various processors of the SoC 202 and SoC 204 may be located within the same SoC. For example, the application processor 216 and low power processor 252 may be located within the same SoC, such as in a single SoC of a wearable device.

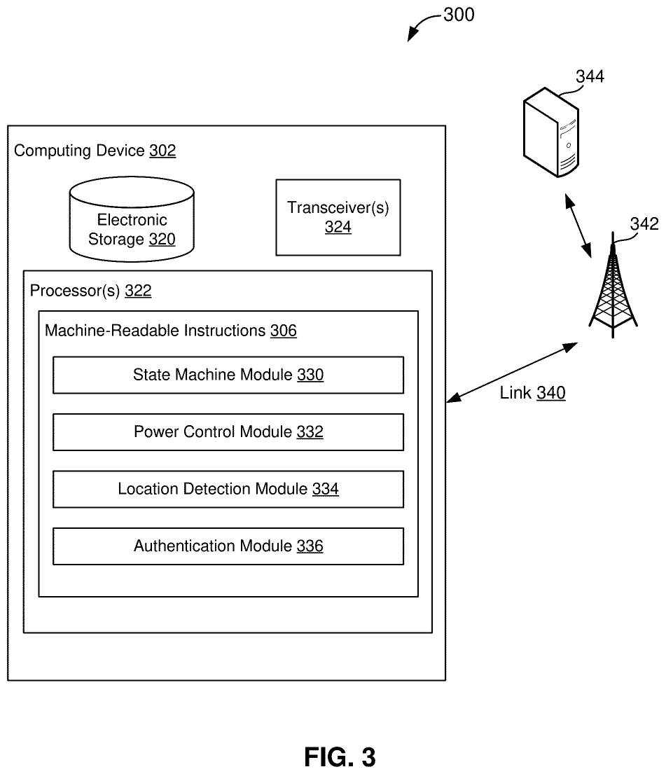

FIG. 3 is a component block diagram illustrating an example system 300 configured to operate in a semi-active state to enable covert communication according to some embodiments. With reference to FIGS. 1-3, the system 300 may include computing device 302 (e.g., 150) and external servers 344, which may communicate via a communication link 340 over network node 342. External server 344 may include sources of information outside of the system 300, external entities participating with the system 300, or other resources. For example, external server(s) 344 may be a computing device that may receive and monitor location updates from computing device(s) 302. In some implementations, some or all of the functionality attributed herein to external servers 344 may be provided by resources included in the system 300. The system 300 may include a plurality of hardware, software, and/or firmware components operating together to provide the functionality attributed herein to the processor 322.

The computing device(s) 302 may include electronic storage 320 that may be configured to store information related to functions implemented by a state machine module 330, a power control module 332, a location detection module 332, an authentication module 336, and any other instruction modules.

The electronic storage 320 may include non-transitory storage media that electronically stores information. The electronic storage 320 may include one or both of system storage that is provided integrally (i.e., substantially non-removable) with the computing device 302 and/or removable storage that is removably connectable to the computing device 302 via, for example, a port (e.g., a universal serial bus (USB) port, a firewire port, etc.) or a drive (e.g., a disk drive, etc.).

In various embodiments, electronic storage 320 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 320 may include one or more virtual storage resources (e.g., cloud storage, a virtual private network, and/or other virtual storage resources). The electronic storage 320 may store software algorithms, information determined by processor(s) 322, and/or other information that enables the system 300 to function as described herein.

The computing device(s) 302 may be configured by machine-readable instructions 306. Machine-readable instructions 306 may include one or more instruction modules. The instruction modules may include computer program modules. The instruction modules may include one or more of the state machine module 330, the power control module 332, the location detection module 334, an authentication module 336, and other instruction modules (not illustrated). The computing device(s) 302 may include processor(s) 322 configured to implement the machine-readable instructions 306 and corresponding modules.

The processor(s) 322 may include one or more local processors that may be configured to provide information processing capabilities in the system 300. As such, the processor(s) 322 may include one or more of a digital processor, an analog processor, a digital circuit designed to process information, an analog circuit designed to process information, a state machine, and/or other mechanisms for electronically processing information. Although the processor(s) 322 is shown in FIG. 3 as a single entity, this is for illustrative purposes only. In some embodiments, the processor(s) 322 may include a plurality of processing units and may be a processing system. These processing units may be physically located within the same device, or the processor(s) 322 may represent processing functionality of a plurality of devices distributed in the system 300.

In some embodiments, the processor(s) 322 executing the state machine module 330 (e.g., state manager 140) may be configured to define a plurality of hardware operating states for the computing device 302 or processors 322. The hardware operating states may include control parameters for a power control or power rail, pointers to firmware and software to execute when entering the state, and data to be loaded into memory upon entering the state. In some embodiments, the processor(s) 322 executing the state machine module 330 may be configured to transition from one state to another based on certain parameters (e.g., inactivity) or inputs (e.g., long key press). In some embodiments, the processor(s) 322 executing the state machine module 330 may include an always-on processor that may operate to perform initial processing on inputs and remains power ON even if the power controller is OFF or if the computing device 302 is completely OFF. For example, the always-on processor may be configured to receive an input when a UE is in an OFF state and perform initial processing to transfer to a boot state and boot process.

In some embodiments, the processor(s) 322 executing the state machine module 330 may be configured to execute in one or more low power modes including a covert low power mode that enables covert communication in a semi-active state of the device. In some embodiments, the processor(s) 322 executing the state machine module 330 may be configured to emulate user-facing functionality of a full shutdown of the device. In some embodiments, the processor(s) 322 executing the state machine module 330 may be configured to establish a first set of processors and transceivers that are powered in the covert low power mode and a second set of processors and transceivers that are in reset in the covert low power mode.

In some embodiments, the processor(s) 322 executing the power control module 332 may be configured to operate the computing device 302 in a covert low power mode that supplies power to one or more transceivers. In some embodiments, the processor(s) 322 executing the power control module 332 may be configured to switch or transition between modes based on notifications from the state machine module 330 (e.g., state manager 140) and, based on the state, turn ON/OFF components of the computing device 302 including one or more processors 322 (as illustrated in FIG. 1). The power control module 332 may be configured to execute one or more instructions that cycle through various communication modes so that computing device 302 may determine the best communication mode for a location.

In some embodiments, the processor(s) 322 executing the power control module 332 may be configured to transition to a covert low power mode that includes turning OFF at least two of: a digital signal processor (DSP), an image signal processor (ISP), a secure processor, a visual display processor, or an audio processor. In some embodiments, the processor(s) 322 executing the power control module 332 may be configured to periodically and iteratively power ON each of the one or more transceivers, the one or more transceivers including at least one of a 5G transceiver, a Wi-Fi transceiver, a BLUETOOTH transceiver, or a near-field communication (NFC) transceiver. In some embodiments, the processor(s) 322 executing the power control module 332 may be configured to operate a first set of processors and transceivers that are powered in the covert low power mode and a second set of processors and transceivers that are in reset in the covert low power mode.

In some embodiments, the processor(s) 322 executing the location detection module 334 may be configured to receive, in the covert low power mode, a global positioning satellite (GPS) signal to determine the location of the UE. The location detection module 334 may include instructions for calculating location from the received GPS signals. In some embodiments, the processor(s) 322 executing the location detection module 334 may be configured to determine location based on round trip time (RTT) in various communication modes (e.g., cellular, Wi-Fi). In some embodiments, the processor(s) 322 executing the location detection module 334 may be configured to determine location based on signal strength from known transmitters (e.g., network node 342).

In some embodiments, the processor(s) 322 executing the authentication module 336 may be configured to process authentication results from one or more applications and inputs. For example, the authentication module 336 may connect to a fingerprint reader, a camera for facial recognition, a keypad for password or pin inputs, and one or more electronic readers to detect authentication cards. In some embodiments, the processor(s) 322 executing the authentication module 336 may be configured to evaluate or validate tokens, hashes, or keys that may be transmitted to the authentication module 336 signifying authentication at a keypad, camera, or electronic reader, for example. The processor(s) 322 executing the authentication module 336 may operate to determine that the shutdown of a UE was not initiated by an authorized user in response to an authentication failure as a part of the shutdown. The processor(s) 322 executing the authentication module 336 may determine whether a user-initiated shutdown of a UE was initiated by an authorized user and provide a notification to a processor configured to remain ON in response to determining that the user-initiated shutdown was not initiated by an authorized user.

The description of the functionality provided by the different modules 330-336 is for illustrative purposes, and is not intended to be limiting, as any of modules 330-336 may provide more or less functionality than is described. For example, one or more of modules 330-336 may be eliminated, and some or all of its functionality may be provided by other ones of modules 330-336. As another example, processor(s) 322 may execute one or more additional modules that may perform some or all of the functionality attributed below to one of modules 330-336. In some embodiments, the state machine module 330, the power control module 332, the location detection module 332, and the authentication module 336 may be implemented by a SoC 150 of the computing device (e.g., 302).

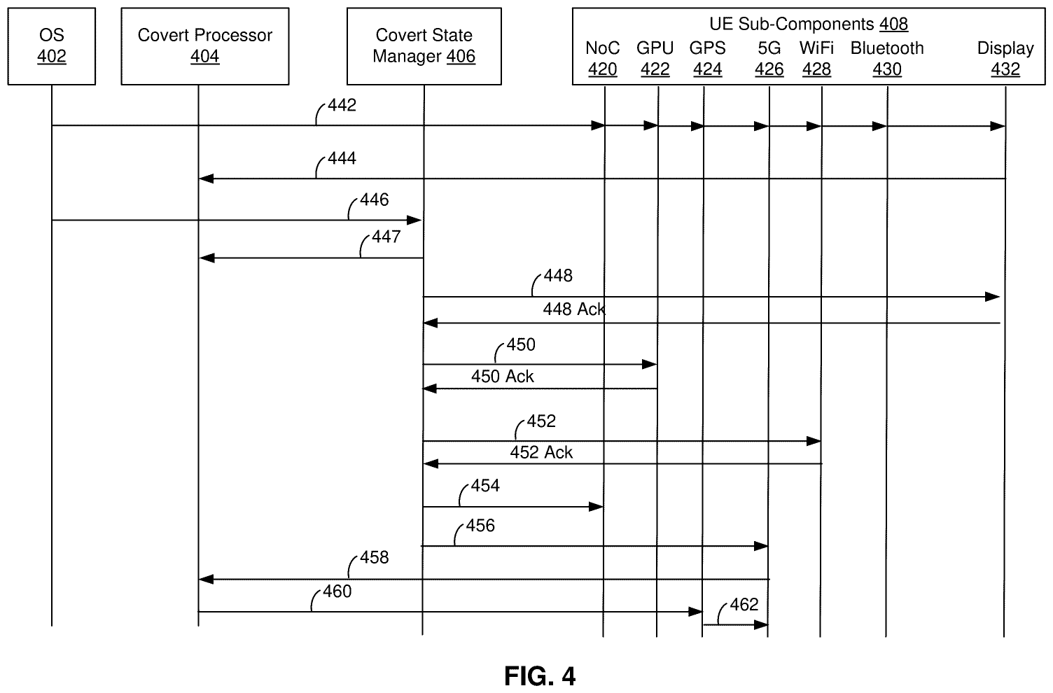

FIG. 4 is a timing diagram illustrating authenticated and unauthenticated signal sequences between various components of the UE according to some embodiments. With reference to FIGS. 1-4, the processes for operating in an authenticated or unauthenticated shutdown may involve an operating system (OS) 402 of the UE, a covert processor (e.g., always on processor) 404, a covert state manager (e.g., state manager 140 executing a covert state), and various US sub-components 408. The UE subcomponents 408 may include a network-on-chip (NoC) 420, graphics processing unit (GPU) 422, a GPS 424, a 5G modem 426, Wi-Fi modem 428, a BLUETOOTH modem 430, and a display 432.

Various embodiments may reduce a number of simultaneously transmitting or available communication modes and may reduce a number of subcomponents (e.g., UE subcomponents 408) being powered, and may, thus, reduce power usage. In other words, the covert communication mode may be a low power mode that extends battery life to increase the time available to find and retrieve the computing device. In an authenticated shutdown, two signals 442 and 444 may be used to complete the process.

In the authenticated shutdown, after the authentication has been provided as part of the user-initiated shutdown or prior to shutdown, the operating system which may have authenticated the shutdown may issue a notification signal to various UE subcomponents as well as the covert processor 404 and the covert state manager 406. The UE subcomponents 408 may receive the notification of the authenticated shutdown and may shut OFF. The UE or one or more of the UE subcomponents 408 may respond with an acknowledgement of the receipt of the shutdown notification as signal 444. The covert state manager 406 may transition the UE to a complete shutdown state where only the covert processor (always-on processor) 404 may be powered on and the covert state manager 406 may transmit (re-transmit) the notification 442 to the UE sub-components 408.

In an unauthenticated shutdown, after a hard shutdown with no authentication (e.g., battery pulled) or a shutdown that is not authenticated or where authentication fails, the OS 402 may notify via signal 446 the covert state manager 406 of the failed authentication (when 404 and 406 are powered). The covert state manager 406 may activate the covert processor 404 via a signal 447 and manage further signaling including component shutdowns and instructions to power controllers to turn OFF components. For example, the covert state manager 406 (e.g., state manager 140, state machine module 330) may transmit shutdown instructions signal 448 to the display 432 (or PMIC thereof) to turn OFF and may receive a 448 Ack signal as an acknowledgement of the shutdown being complete.

Likewise, the covert state manager 406 may transmit a shutdown signal 450 to the GPU 422 and may receive a 450 Ack signal acknowledging receipt or shutdown of the GPU. The covert state manager 406 may transmit a state change signal 452 to the Wi-Fi modem 428 and may receive a 450 Ack signal acknowledging receipt or shutdown or entry of low power mode from the Wi-Fi modem. The covert state manager 406 may transmit a state change signal 454 to the NoC 420 (e.g., low power mode) and may further transmit a state change signal 456 to the 5G modem 426 (e.g., low power mode). The state change signals may modify one or more switches at a power management circuit to switch ON/OFF UE subcomponents 408 as described above.

After an unauthorized shutdown, the UE may be in a semi-active state where the OS 402 is shut down as well as hardware components. The 5G modem 426 may remain connected to a network and may periodically transmit information including location and status information. When the 5G modem 426 can connect to a network, the modem may send an interrupt request (IRQ) 458 to the covert processor 404 to inform it of the covert communication capability. The covert processor 404 may transmit a location request or GPS detection/monitoring signal 460 to the GPS 424 to determine a location of the UE. The location of the UE may then be transmitted in message signal 462 to the 5G modem 426 which may then relay the message and location to an external recipient (e.g., true owner). The signal order illustrated in FIG. 4 is intended as a non-limiting example and signals may be re-ordered to improve power usage or communication differently. Depending on the implementation, the OS 402, the covert processor 404, or the covert state manager 406 may perform any of the state signaling operations described above.

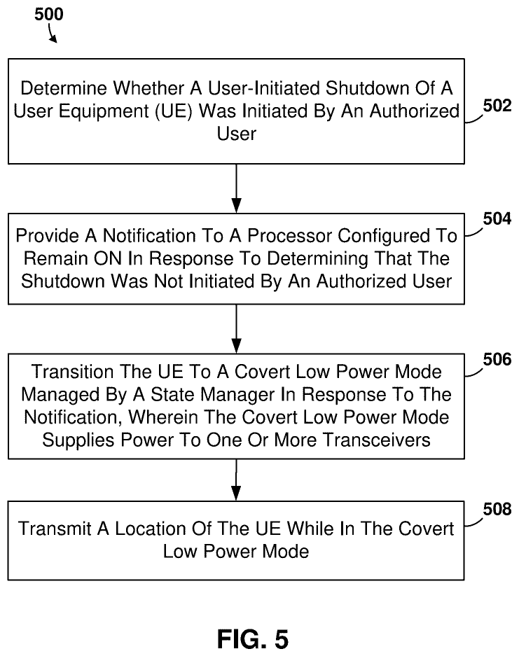

FIG. 5 is a process flow diagram of an example method for switching to a covert state in an unauthorized shutdown according to various embodiments. With reference to FIGS. 1-5, the method 500 may be performed by a UE, such as a smartphone or other mobile computing device that includes a processing system (e.g., 150, 200, 322) and a wireless transceiver (e.g., 324, 266). In some embodiments, the UE may include a processor (e.g., processor 322, 404, 406) configured to perform the operations by processor-executable instructions stored in a non-transitory processor-readable medium (e.g., memory 320, 220). Means for performing the operations of the method 600 may be a processing system (e.g., 150, 200, 322) including one or more processors (e.g., 210, 212, 214, 216, 218, 221, 222, 252, 260, 322, 324, 404, 406, etc.), a wireless transceiver (e.g., 324, 266), and other components described herein. To encompass any of the processor(s), hardware elements and software elements that may be involved in performing the method 500, the elements performing method operations are referred to as a “processing system” or a “processor configured to remain ON” while in the cover low power mode.

In block 502, the processing system of the UE may determine whether a user-initiated shutdown of the UE was initiated by an authorized user. As noted above, this determination may include checking whether the shutdown occurred while the device was unlocked, logged in or otherwise authenticated, or requesting/receiving authentication at the time of shutdown.

In block 504, the processing system may provide a notification to a processor configured to remain ON in response to determining that the user-initiated shutdown was not initiated by an authorized user. As noted above, this notification may be transmitted to the covert processor (e.g., 404), which may be an always-on processor, to configure operations. A notification may also be transmitted in response to a shutdown that is authorized by a user, which may configure operations of the UE and may result in a full shutdown (in which only the covert/always-on processor is power on). The notification may include multiple notifications from various applications (e.g., authorization application and settings application) or the OS.

In block 506, the processing system may transition the UE to a covert low power mode managed by a state manager in response to the notification, where the covert low power mode supplies power to one or more transceivers. The transition to the covert low power mode may include turning OFF at least two of: a digital signal processor (DSP), an image signal processor (ISP), a secure processor, a visual display processor, or an audio processor. The UE in the covert low power mode may be configured to periodically and iteratively power ON each of the one or more transceivers, the one or more transceivers including at least one of a 5G transceiver, a Wi-Fi transceiver, a BLUETOOTH transceiver, or a near-field communication (NFC) transceiver. The UE in the covert low power mode may be configured to emulate user-facing functionality of a full shutdown of the device. The state manager may configure a first set of processors and transceivers that are powered in the covert low power mode and a second set of processors and transceivers that are reset in the covert low power mode.

In block 508, the processor configured to remain ON may transmit a location of the UE while in the covert low power mode. For example, the UE may receive, in the covert low power mode, a global positioning satellite (GPS) signal to determine the location of the UE and then transmit the location of the UE in the covert low power mode. As described above, the location may be sourced from a number of location-determining processes (e.g., RTT). The location may be transmitted via one or more different communication channels or methods.

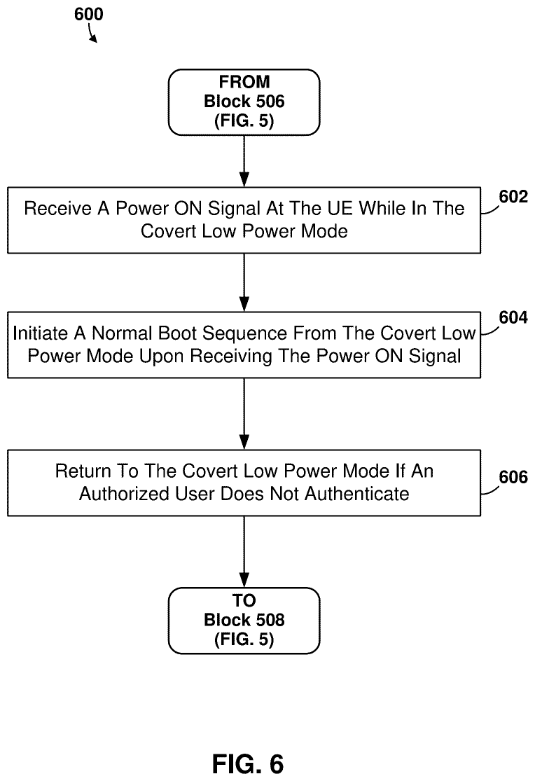

FIG. 6 is a process flow diagram of an example method for switching to a covert state in an unauthorized restart/shutdown according to various embodiments. With reference to FIGS. 1-6, the method 600 may be performed by a UE, such as a smartphone or other mobile computing device that includes a processing system (e.g., 150, 200, 322) and a wireless transceiver (e.g., 324, 266). In some embodiments, the UE may include a processor (e.g., processor 322, 404, 406) configured to perform the operations by processor-executable instructions stored in a non-transitory processor-readable medium (e.g., memory 320, 220). Means for performing the operations of the method 600 may be a processing system (e.g., 150, 200, 322) including one or more processors (e.g., 210, 212, 214, 216, 218, 221, 222, 252, 260, 322, 324, 404, 406 etc.), a wireless transceiver (e.g., 324, 266), and other components described herein. To encompass any of the processor(s), hardware elements and software elements that may be involved in performing the method 600, the elements performing method operations are referred to as a “processing system” or a “processor configured to remain ON” while in the cover low power mode.

While the UE is in the covert low power mode, the processor configured to remain ON may receive a power ON signal for the UE in block 602. That is, while in a semi-active state, the UE may be triggered to start up again (e.g., by a thief after an escape) and the always-on processor may receive that power ON signal.

In block 604, the processor configured to remain ON and/or the processing system may initiate a normal boot sequence from the covert low power mode (e.g., semi-active state) upon receiving the power ON signal. That is, the processing system may transition to an active state, a boot state, or a normal operating state in what appears to be a normal manner to the user, appearing the same as a boot from a normal shutdown. For example, a start screen may be displayed while the OS boots.

In block 606, if an authorized user does not authenticate, such as be recognized via biometric data (e.g., facial recognition) and/or enter a correct personal identification number (PIN) or password, the processor configured to remain ON and/or the processing system may return the UE to the covert low power mode. That is, once the UE is booted, the UE may prompt the user to perform a normal authentication procedure (e.g., request entry of a PIN, activate the camera to perform facial recognition, obtain data from a fingerprint sensor, etc.). If this authentication procedure fails or is not complete, then the UE may return to the covert low power mode to preserve battery life and periodically or episodically transmit location information. For example, when the UE is booted, a lack of authentication may result in an unauthenticated shutdown by performing the operations in blocks 502-508 of the method 500, resulting in a return to the covert low power mode and the reporting or transmitting of location information to assist recovery of the UE in block 508 as described.

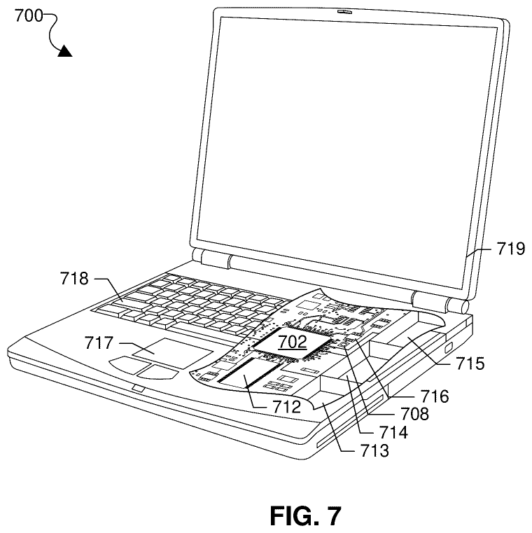

The various embodiments (including, but not limited to, embodiments described above with reference to FIGS. 1-6) may be implemented in a wide variety of computing systems include a laptop computer 700, an example of which is illustrated in FIG. 7. With reference to FIGS. 1-7, a laptop computer may include a touchpad touch surface 717 that serves as the computer's pointing device, and thus may receive drag, scroll, and flick gestures similar to those implemented on computing devices equipped with a touch screen display and described above. A laptop computer 700 will typically include a processor 702 coupled to volatile memory 712 and a large capacity nonvolatile memory, such as a disk drive 713 of Flash memory. Additionally, the computer 700 may have one or more antenna 708 for sending and receiving electromagnetic radiation that may be connected to a wireless data link and/or cellular telephone transceiver 716 coupled to the processor 702. The computer 700 may also include a floppy disc drive 714 and a compact disc (CD) drive 715 coupled to the processor 702. The laptop computer 700 may include a touchpad 717, a keyboard 718, and a display 719 all coupled to the processor 702. Other configurations of the computing device may include a computer mouse or trackball coupled to the processor (e.g., via a USB input) as are well known, which may also be used in conjunction with the various embodiments.

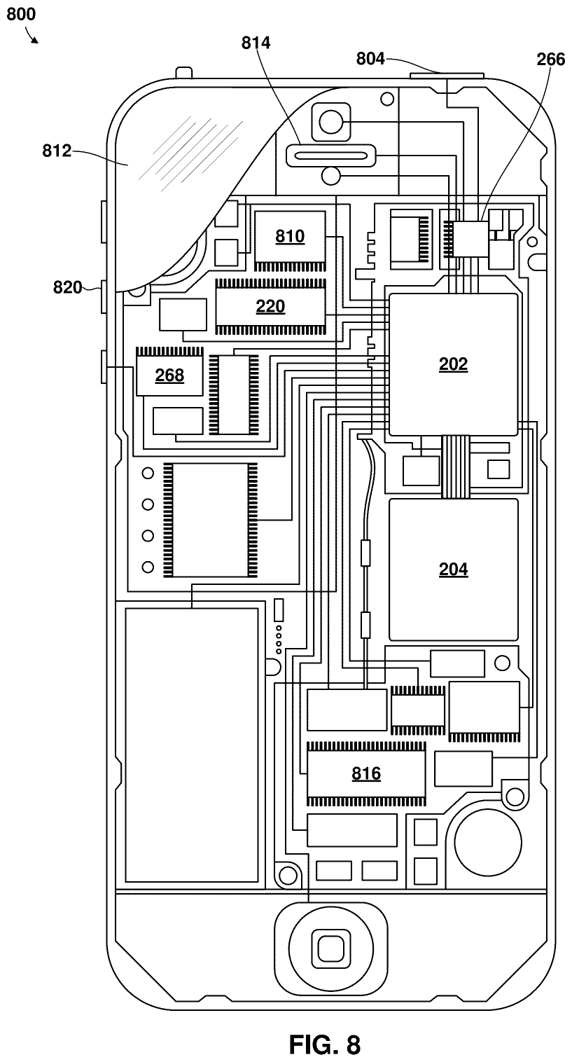

FIG. 8 is a component block diagram of a computing device 800 suitable for use with various embodiments. With reference to FIGS. 1-8, various embodiments may be implemented on a variety of computing devices 800 (e.g., computing device 302), an example of which is illustrated in FIG. 8 in the form of a smartphone. The computing device 800 may include a first SoC 202 (e.g., a SoC-CPU) coupled to a second SoC 204 (e.g., a 5G capable SoC). The first and second SoCs 202, 204 may be coupled to internal memory 816, a display 812, and to a speaker 814. The first and second SoCs 202, 204 may also be coupled to at least one SIM 268 and/or a SIM interface that may store information supporting a first 5GNR subscription and a second 5GNR subscription, which support service on a 5G non-standalone (NSA) network.

The computing device 800 may include an antenna 804 for sending and receiving electromagnetic radiation that may be connected to a wireless transceiver 266 coupled to one or more processors in the first and/or second SoCs 202, 204. The computing device 800 may also include menu selection buttons or rocker switches 820 for receiving user inputs. These rocker switches 820 or switch 804 may be long-pressed to generate a shutdown input or a start-up input (depending on the UE state), which may be received by an always-on processor for processing.

The computing device 800 also includes a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SoCs 202, 204, wireless transceiver 266 and CODEC 810 may include a digital signal processor (DSP) circuit (not shown separately).

The processors of the computer 700 and the computing device 800 may be any programmable microprocessor, microcomputer or multiple processor chip or chips that can be configured by software instructions (applications) to perform a variety of functions, including the functions of the various embodiments described below. In some UEs, multiple processors may be provided, such as one processor within an SoC 204 dedicated to wireless communication functions and one processor within an SoC 202 dedicated to running other applications. Software applications may be stored in the memory 220, 816 before they are accessed and loaded into the processor. The processors may include internal memory sufficient to store the application software instructions.

Implementation examples are described in the following paragraphs. While some of the following implementation examples are described in terms of example methods that may be performed in a computing device by a host controller, further example implementations may include: a computing device including a host controller configured to perform the methods of the following implementation examples; a computing device including means for performing functions of the following implementation examples, a host controller suitable for use in a computing device, in which the host controller includes a processor configured to perform the methods of the following implementation examples; and a non-transitory, processor-readable memory having stored thereon processor-executable instructions configured to cause a host controller in a computing device configured to perform the methods of the following implementation examples.

Example 1. A method of maintaining covert communications by a user equipment (UE), including: determining whether a user-initiated shutdown of the UE was initiated by an authorized user; providing a notification to a processor configured to remain ON in response to determining that the user-initiated shutdown was not initiated by the authorized user; transitioning the UE to a covert low power mode managed by a state manager in response to the notification, in which the covert low power mode supplies power to one or more transceivers; and transmitting a location of the UE while in the covert low power mode.

Example 2. The method of example 1, in which transitioning to the covert low power mode further including: turning OFF at least two of: a digital signal processor (DSP), an image signal processor (ISP), a secure processor, a visual display processor, or an audio processor.

Example 3. The method of either of examples 1 or 2, further including periodically and iteratively power ON each of the one or more transceivers while the UE is in the covert low power mode, the one or more transceivers including at least one of a 5G transceiver, a Wi-Fi transceiver, a BLUETOOTH transceiver, or a near-field communication (NFC) transceiver.

Example 4. The method of any of examples 1-3, further including: processing a received global positioning satellite (GPS) signal to determine the location of the UE while in the covert low power mode; and transmitting the location of the UE determined from the GPS signal while in the covert low power mode.

Example 5. The method of any of examples 1-4, in which determining whether a user-initiated shutdown of the UE was initiated by the authorized user includes determining that the user-initiated shutdown was not initiated by the authorized user in response to an authentication failure as a part of the user-initiated shutdown.

Example 6. The method of any of examples 1-5, further including emulating user-facing functionality of a full shutdown of the UE while the UE is in the covert low power mode.

Example 7. The method of any of examples 1-6, in which transitioning the UE to the covert low power mode managed by the state manager includes the state manager configuring a first set of processors and transceivers that are powered in the covert low power mode and configuring a second set of processors and transceivers that are in reset in the covert low power mode.

Example 8. The method of any of examples 1-8, further including: receiving a power ON signal while in the covert low power mode; initiating a normal boot sequence from the covert low power mode upon receiving the power ON signal; and returning to the covert low power mode if the authorized user does not authenticate during the normal boot sequence.

Example 9. A user equipment (UE) including: a wireless transceiver; a covert processor; a covert state manager; and a processor executing an operating system coupled to the wireless transceiver, covert processor and covert state manager, in which: the processor is configured to notify the covert state manager in the event of a hard shutdown of the UE without authentication of a user; the covert state manager is configured to initiate a covert low power mode by: signaling the wireless transceiver and the covert processor to enter the covert low power mode; and powering down the processor and other subcomponents of the UE; the wireless transceiver is configured to periodically monitor for an accessible wireless network while in the covert low power mode and signal the covert processor in response to identifying an accessible wireless network; and the covert processor is configured to cause the wireless transceiver to transmit information including UE location and status information in response to the signal identifying the accessible network.

Example 10. The UE of example 9, further including a Global Positioning System (GPS) receiver coupled to the covert processor, in which the covert processor is further configured to: request UE location information from the GPS receiver in response to the signal identifying the accessible network; and provide UE location information received from the GPS receiver to the wireless transceiver for inclusion in transmissions of UE location and status information.

Example 11. The UE of either of examples 9 or 10, in which the wireless transceiver includes at least one of a 5G transceiver, a Wi-Fi transceiver, a BLUETOOTH transceiver, or a near-field communication (NFC) transceiver.

Example 12. The UE of any of examples 9-11, in which the covert processor is further configured to emulate user-facing functionality of a full shutdown of the UE while the UE is in the covert low power mode.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), Long Term Evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of maintaining covert communications by a user equipment (UE), comprising:
determining whether a user-initiated shutdown of the UE was initiated by an authorized user;
providing a notification to a processor configured to remain ON in response to determining that the user-initiated shutdown was not initiated by the authorized user;
transitioning the UE to a covert low power mode managed by a state manager in response to the notification, wherein the covert low power mode supplies power to one or more transceivers; and
transmitting a location of the UE while in the covert low power mode.

2. The method of claim 1, wherein transitioning to the covert low power mode further comprising:
turning OFF at least two of: a digital signal processor (DSP), an image signal processor (ISP), a secure processor, a visual display processor, or an audio processor.

3. The method of claim 1, further comprising periodically and iteratively power ON each of the one or more transceivers while the UE is in the covert low power mode, the one or more transceivers including at least one of a 5G transceiver, a Wi-Fi transceiver, a BLUETOOTH transceiver, or a near-field communication (NFC) transceiver.

4. The method of claim 1, further comprising:
processing a received global positioning satellite (GPS) signal to determine the location of the UE while in the covert low power mode; and
transmitting the location of the UE determined from the GPS signal while in the covert low power mode.

5. The method of claim 1, wherein determining whether the user-initiated shutdown of the UE was initiated by the authorized user comprises determining that the user-initiated shutdown was not initiated by the authorized user in response to an authentication failure as a part of the user-initiated shutdown.

6. The method of claim 1, further comprising emulating user-facing functionality of a full shutdown of the UE while the UE is in the covert low power mode.

7. The method of claim 1, wherein transitioning the UE to the covert low power mode managed by the state manager comprises the state manager configuring a first set of processors and transceivers that are powered in the covert low power mode and configuring a second set of processors and transceivers that are in reset in the covert low power mode.

8. The method of claim 1, further comprising:
receiving a power ON signal while in the covert low power mode;
initiating a normal boot sequence from the covert low power mode upon receiving the power ON signal; and
returning to the covert low power mode if the authorized user does not authenticate during the normal boot sequence.

9. A user equipment (UE), comprising:
one or more wireless transceivers;
a memory; and
a processing system coupled to the one or more wireless transceivers and the memory and including one or more processors configured to:
determine whether a user-initiated shutdown of the UE was initiated by an authorized user;
provide a notification to a processor configured to remain ON in response to determining that the user-initiated shutdown was not initiated by the authorized user;
transition the UE to a covert low power mode managed by a state manager in response to the notification, wherein the covert low power mode supplies power to one or more transceivers; and
transmit a location of the UE while in the covert low power mode.

10. The UE of claim 9, wherein the one or more processors are configured to transition to the covert low power mode by turning OFF at least two of: a digital signal processor (DSP), an image signal processor (ISP), a secure processor, a visual display processor, or an audio processor.

11. The UE of claim 9, wherein the one or more processors are further configured to periodically and iteratively power ON each of the one or more transceivers while the UE is in the covert low power mode, the one or more transceivers including at least one of a 5G transceiver, a Wi-Fi transceiver, a BLUETOOTH transceiver, or a near-field communication (NFC) transceiver.

12. The UE of claim 9, wherein the one or more processors are further configured to:
process a received global positioning satellite (GPS) signal to determine the location of the UE while in the covert low power mode; and
transmit the location of the UE determined from the GPS signal while in the covert low power mode.

13. The UE of claim 9, wherein the one or more processors are configured to determine that the user-initiated shutdown was not initiated by the authorized user in response to an authentication failure as a part of the user-initiated shutdown.

14. The UE of claim 9, wherein the one or more processors are configured to emulate user-facing functionality of a full shutdown of the UE while the UE is in the covert low power mode.

15. The UE of claim 9, wherein the one or more processors are configured to transition the UE to the covert low power mode managed by the state manager by the state manager configuring a first set of processors and transceivers that are powered in the covert low power mode and configuring a second set of processors and transceivers that are in reset in the covert low power mode.

16. The UE of claim 9, wherein the one or more processors are configured to:
receive a power ON signal while in the covert low power mode;
initiate a normal boot sequence from the covert low power mode upon receiving the power ON signal; and
return to the covert low power mode if the authorized user does not authenticate during the normal boot sequence.

17. A user equipment (UE) comprising:
a wireless transceiver;
a covert processor;
a covert state manager; and
a processor executing an operating system coupled to the wireless transceiver, covert processor, and covert state manager,
wherein:
the processor is configured to notify the covert state manager in the event of a hard shutdown of the UE without authentication of a user;
the covert state manager is configured to initiate a covert low power mode by:
signaling the wireless transceiver and the covert processor to enter the covert low power mode; and
powering down the processor and other subcomponents of the UE;
the wireless transceiver is configured to periodically monitor for an accessible wireless network while in the covert low power mode and signal the covert processor in response to identifying an accessible wireless network; and
the covert processor is configured to cause the wireless transceiver to transmit information including UE location and status information in response to the signal identifying the accessible network.

18. The UE of claim 17, further comprising a Global Positioning System (GPS) receiver coupled to the covert processor, wherein the covert processor is further configured to:
request UE location information from the GPS receiver in response to the signal identifying the accessible network; and
provide UE location information received from the GPS receiver to the wireless transceiver for inclusion in transmissions of UE location and status information.

19. The UE of claim 17, wherein the wireless transceiver comprises at least one of a 5G transceiver, a Wi-Fi transceiver, a BLUETOOTH transceiver, or a near-field communication (NFC) transceiver.

20. The UE of claim 17, wherein the covert processor is further configured to emulate user-facing functionality of a full shutdown of the UE while the UE is in the covert low power mode.
